(19) United States
(12) Patent Application Publication
(10) Pub. No.: US 2011/0233920 A1
(43) Pub. Date: Sep. 29, 2011

(54) MULTI-LAYERED LABEL FOR A LETTER OR PACKAGE

(75) Inventors: Ted Shanley, Freeland, WA (US); Dan VanWaveren, Snohomish, WA (US)

(73) Assignee: EMERALD CITY LABEL, INC.

(21) Appl. No.: 13/048,166

(22) Filed: Mar. 15, 2011

Related U.S. Application Data
(60) Provisional application No. 61/317,363, filed on Mar. 25, 2010.

(51) Int. Cl. B42D 15/10

(52) U.S. Cl. 283/81

(57) ABSTRACT

A label includes a first section and a second section that is attached to the first section. The first section includes a panel. The panel includes one or more sides that are detachable from the first section.

This application claims the benefit of priority under 35 U.S.C. 119(e) to U.S. Provisional Patent Application Ser. No. 61/317,363, filed on Mar. 25, 2010, which is incorporated herein by reference in its entirety.

### BACKGROUND

Labels are generally applied to letters and packages for a variety of purposes. For example, the label may include information about the contents of a letter or package, or it may include information about an addressee of the letter or the package.

### BRIEF DESCRIPTION OF THE FIGURES

FIG. 1 is a diagrammatic view of a multi-layered label, according to the various embodiments.

FIG. 2 is another diagrammatic view of the multi-layered label of FIG. 1, according to the various embodiments.

FIG. 3 is still another diagrammatic view of the multi-layered label of FIG. 1, according to the various embodiments.

FIG. 4 is still another diagrammatic view of the multi-layered label of FIG. 1, according to the various embodiments.

FIG. 5 is a plan view of an underside of the multi-layered label, according to the various embodiments.

FIG. 6 is a partial isometric view of the underside of the multi-layered label, according to the various embodiments.

### DETAILED DESCRIPTION

In the following description, reference may be made to the accompanying drawings that form a portion of the present disclosure, and show by way of illustration, various embodiments that may be practiced. Although the various embodiments are described in sufficient detail to permit those skilled in the art to practice the various embodiments, still other embodiments may be possible through various structural changes without departing from the scope of the present disclosure.

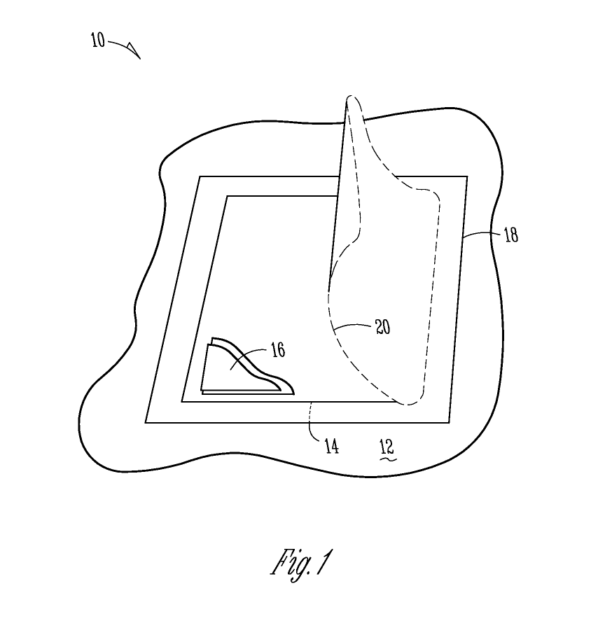

FIG. 1 is a diagrammatic view of a multi-layer label 10, according to the various embodiments. The label 10 may be configured to be positioned on a surface 12 of a letter, a package or parcel, or other similar articles. The label 10 may be configured to be adhesively attached to the surface 12. Accordingly, the label 10 may include an adhesive material 14 that is concealed by a backing material (not shown in FIG. 1) that may be removed to expose the adhesive material 14 prior to affixing the label 10 to the surface 12. The adhesive material 14 may be activated by the introduction of moisture to the adhesive material 14 (e.g., a gummed backing) Alternatively, the adhesive material 14 may be applied to the label 10 by brushing, spraying, or rolling a suitable adhesive onto the label 10, or onto the surface 12 prior to positioning the label 10 onto the surface 12. The label 10 may also include one or more panels 16 that may be concealed beneath an external panel 18. The external panel 18 may also include a detachable panel 20 that may be configured to be at least partially separable from the external panel 18, so that the one or more panels 16 may be exposed after the label 10 is applied to the surface 12. The one or more panels 16, the external panel 18 and the detachable panel 20 will be discussed in greater detail below.

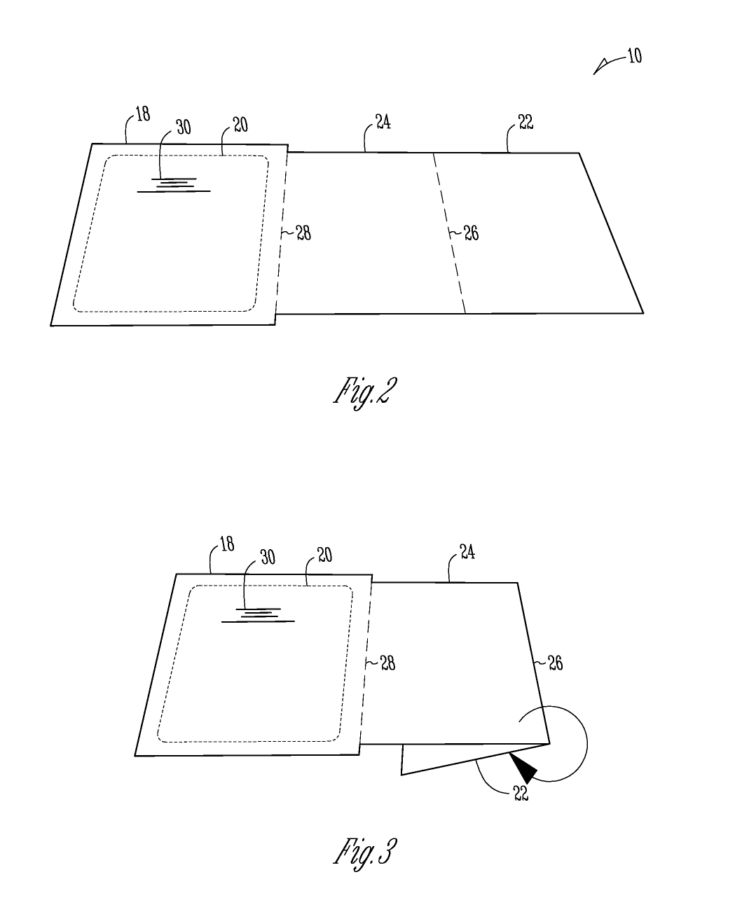

FIG. 2 is another diagrammatic view of the label 10 of FIG. 1, according to the various embodiments. The label 10 may include a first panel 22 and a second panel 24 hingeably attached to the first panel 22 by a fold line 26. The second panel 24 may be further attached to the external panel 18 by a scored line 28. The scored line 28 will be discussed in detail below. The first panel 22 and the second panel 24 may be configured to include various written and/or graphical representations, including promotional information for various commercial products and/or services, and may be further configured to include a personalized message. In accordance with an embodiment, at least a portion of the first panel 22 may include a personalized message that may be directly viewed when the detachable panel 20 is at least partially removed from the external panel 18. In accordance with another embodiment, the first panel 22 may be omitted, so that only a single panel (e.g., the second panel 24) may be concealed by the external panel 18.

Still referring to FIG. 2, the detachable panel 20 of the external panel 18 may also be configured to include various written and/or graphical information 30. For example, the written and/or graphical information 30 may include an identification of an addressor (e.g., a shipper, or a sender), an addressee (e.g., a recipient), or other pertinent information, such as information provided by a carrier that handles the shipping of the item attached to the label 10. The written and/or graphical information 30 may therefore include written (e.g., plain language) information and it may also include coded information in various forms, such as one-dimensional or two-dimensional bar code information, for example.

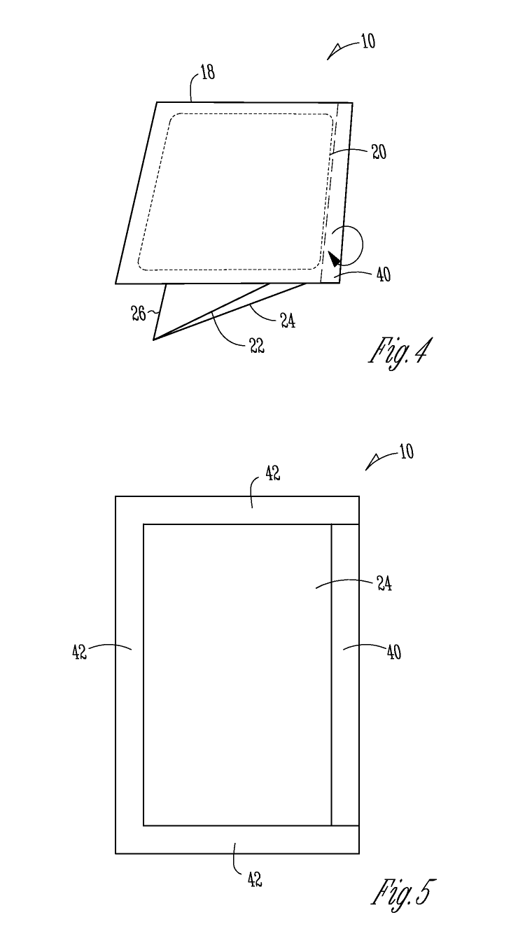

Referring now to FIG. 3, and prior to attaching the label 10 to the surface 12 (as shown in FIG. 1), the first panel 22 of the label 10 may be configured to be rotated about the fold line 26 and towards an underside of the second panel 24. Turning now to FIG. 4, the first panel 22 and the second panel 24 may be rotated in unison, as shown, to abut an underside of the detachable panel 20. The first panel 22 and the second panel 24 may be substantially aligned with the detachable panel 20 following the rotation shown in FIG. 4. As the first panel 22 and the second panel 24 are rotated, a first adhesive portion 40 of the adhesive material 14 may be exposed by the removal of the backing material from the adhesive material 14.

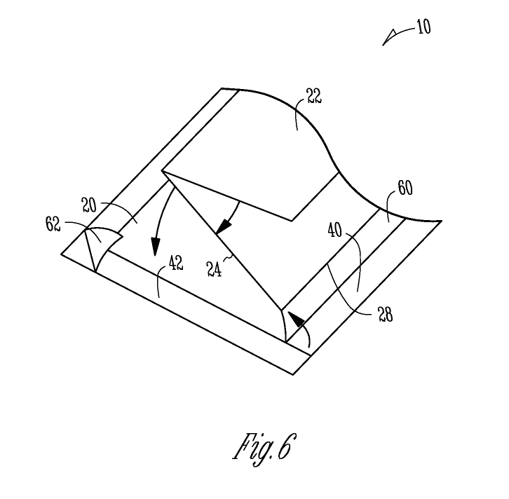

FIG. 5 is a plan view of an underside of the label 10, according to the various embodiments. Since the first panel 22 and the second panel 24 are rotated to an underside of the label 10, as discussed in connection with FIG. 4, the first adhesive portion 40 is exposed and is prepared to be applied to the surface 12 (as shown in FIG. 1). Prior to application of the label 10 to the surface, a second adhesive portion 42 may be removed from the underside of the label 10, whereupon the label 10 may be adhesively attached to the surface 12.

With reference now to FIG. 6, a partial isometric view of the underside of the label 10 is shown that will be used to further describe the first adhesive portion 40, according to the various embodiments. The scored line 28 may be configured to be pulled away from the first adhesive portion 40, so that the first panel 22 and the second panel 24 remain attached to the label 10 by a backing material 60 as the first panel 22 and the second panel 24 are rotated into contact with an underside of the detachable panel 20. The backing material 62 may also be removed from the second adhesive portion 42, so that the first adhesive portion 40 and the second adhesive portion 42 cooperatively adhere the label 10 to the surface 12 (as shown in FIG. 1).

### Example Embodiments

Example No. 1 is a label that includes a first section and a second section. The second section is attached to the first section. The first section includes a panel, and the panel includes one or more sides that are detachable from the first section.

Example No. 2 includes the features of Example No. 1, and optionally includes a label wherein the second section is detachable from the first section.

Example No. 3 includes the features of Example Nos. 1-2, and optionally includes a label wherein the panel is substantially centered within an area of the first section, and wherein the panel and first section are configured such that three sides of the panel are detachable from the first section, while a fourth side of the panel remains attached to the first section, thereby permitting the panel to rotate or pivot about a line formed by the fourth side and the first section.

Example No. 4 includes the features of Examples Nos. 1-3, and optionally includes a label wherein the fourth side of the panel is detachable from the first section.

Example No. 5 includes the features of Examples Nos. 1-4, and optionally includes a label including an adhesive on an underside of the first section.

Example No. 6 includes the features of Examples Nos. 1-5, and optionally includes a label including an adhesive on an underside of the second section.

Example No. 7 includes the features of Examples Nos. 1-6, and optionally includes a label including a peelable covering over the adhesive on the underside of the first section and a peelable covering over the adhesive on the underside of the second section.

Example No. 8 includes the features of Examples Nos. 1-7, and optionally includes a label wherein the first section includes a subsection at a point of attachment between the first section and the second section such that upon rotating or pivoting the second section about the point of attachment, the second section separates from the first section and exposes an underside of the subsection, wherein the underside of the subsection comprises an adhesive.

Example No. 9 includes the features of Examples Nos. 1-8, and optionally includes a label wherein the first section and second section are configured such that upon rotating or pivoting the second section, the second section is positioned adjacent to the underside of the first section, and the sides of the panel are configured such that a removal of the panel from the first section exposes the second section.

Example No. 10 includes the features of Examples Nos. 1-9, and optionally includes a label wherein the first section includes a perimeter around the panel, such that when the second section is positioned adjacent the underside of the first section, the perimeter outlines the second section.

Example No. 11 includes the features of Examples Nos. 1-10, and optionally includes a label wherein the one or more sides of the panel are coupled to the first section via a perforated edge.

Example No. 12 includes the features of Examples Nos. 1-11, and optionally includes a label wherein the label is configured for attachment to a letter, package, or other parcel.

Example No. 13 includes the features of Examples Nos. 1-12, and optionally includes a label including a third section attached to the second section.

Example No. 14 includes the features of Examples Nos. 1-13, and optionally includes a label wherein one or more of the second section and the third section comprise one or more of a promotional message, a commercial message, an advertizing message, a personal message, and a return mailing label.

Example No. 15 includes the features of Examples Nos. 1-14, and optionally includes a label wherein the third section is detachable from the second section on a side that is opposite the side at which the second section is attached to the first section.

Example No. 16 includes the features of Examples Nos. 1-15, and optionally includes a label wherein the second section is attached to the first section via a score line.

Example No. 17 includes the features of Examples Nos. 1-16, and optionally includes a label wherein the third section is attached to the second section via a fold line.

Example No. 18 includes the features of Examples Nos. 1-17, and optionally includes a label wherein the second section and the third section are configured such that upon rotating or pivoting the third section about the fold line, and upon rotating or pivoting the second section about the score line, the second section and the third section are positioned adjacent to the underside of the first section, and the sides of the panel are configured such that a removal of the panel from the first section exposes the second section and the third section, and wherein the first section comprises a perimeter around the panel such that when the second section and third section are positioned adjacent to the underside of the first section, the perimeter outlines the second section and the third section.

Example No. 19 includes the features of Examples Nos. 1-18, and optionally includes a label wherein upon positioning the second section and the third section adjacent to the underside of the first section, a subsection adjacent to the score line is exposed, the subsection comprising an adhesive on an underside of the subsection.

Example No. 20 includes the features of Examples Nos. 1-19, and optionally includes a label including a perimeter around the first section, the perimeter comprising an adhesive on an underside of the perimeter.

Example No. 21 includes the features of Examples Nos. 1-20, and optionally includes a label wherein the first section comprises one or more of addressor information, addressee information, shipper information, and a computer readable code such as a one or two dimensional bar code.

Example No. 22 is a label that includes a first section, and a second section that is detachably coupled to the first section. The first section includes a panel, and the panel includes one or more sides that are detachable from the first section. The panel is substantially centered within an area of the first section. The first section includes a subsection at a point of attachment between the first section and the second section such that upon rotating or pivoting the second section about the point of attachment, the second section separates from the first section and exposes an underside of the subsection. The underside of the subsection comprises an adhesive. The first section and second section are configured such that upon rotating or pivoting the second section, the second section is positioned adjacent to the underside of the first section, and the sides of the panel are configured such that a removal of the panel from the first section exposes the second section.

Example No. 23 includes the features of Examples No. 22, and optionally includes a label including an adhesive on an underside of the first section and an adhesive on an underside of the second section.

Example No. 24 includes the features of Examples Nos. 22-23, and optionally includes a label including a third section attached to the second section.

Example No. 25 includes the features of Examples Nos. 22-24, and optionally includes a label wherein the third section is detachable from the second section on a side that is opposite the side at which the second section is attached to the first section.

Example No. 26 includes the features of Examples Nos. 22-25, and optionally includes a label wherein the second section is attached to the first section via a score line.

Example No. 27 includes the features of Examples Nos. 22-26, and optionally includes a label wherein the third section is attached to the second section via a fold line.

Example No. 28 includes the features of Examples Nos. 22-27, and optionally includes a label wherein the second section and the third section are configured such that upon rotating or pivoting the third section about the fold line, and upon rotating or pivoting the second section about the score line, the second section and the third section are positioned adjacent to an underside of the first section. The sides of the panel are configured such that a removal of the panel from the first section exposes the second section and the third section. The first section includes a perimeter around the panel such that when the second section and third section are positioned adjacent to the underside of the first section, the perimeter outlines the second section and the third section.

While the various embodiments have been illustrated and described, as noted above, this Detailed Description is not to be taken in a limiting sense. Instead, this disclosure is intended to cover adaptations or variations of the various embodiments. Combinations of the various embodiments, and other embodiments not specifically described herein, will be apparent to those of ordinary skill in the art upon reviewing the above description.

1. A label comprising:
a first section; and
a second section attached to the first section;
wherein the first section comprises a panel, the panel comprising one or more sides that are detachable from the first section.

2. The label of claim 1, wherein the second section is detachable from the first section.

3. The label of claim 1, wherein the panel is substantially centered within an area of the first section, and wherein the panel and first section are configured such that three sides of the panel are detachable from the first section, while a fourth side of the panel remains attached to the first section, thereby permitting the panel to pivot about a line formed by the fourth side and the first section.

4. The label of claim 3, wherein the fourth side of the panel is detachable from the first section.

5. The label of claim 1, comprising an adhesive on an underside of the first section.

6. The label of claim 5, comprising an adhesive on an underside of the second section.

7. The label of claim 6, comprising a peelable covering over the adhesive on the underside of the first section and a peelable covering over the adhesive on the underside of the second section.

8. The label of claim 7, wherein the first section comprises a subsection at a point of attachment between the first section and the second section such that upon pivoting the second section about the point of attachment, the second section separates from the first section and exposes an underside of the subsection, wherein the underside of the subsection comprises an adhesive.

9. The label of claim 8, wherein the first section and second section are configured such that upon pivoting the second section, the second section is positioned adjacent to the underside of the first section, and the sides of the panel are configured such that a removal of the panel from the first section exposes the second section.

10. The label of claim 9, wherein the first section comprises a perimeter around the panel, such that when the second section is positioned adjacent the underside of the first section, the perimeter outlines the second section.

11. The label of claim 1, wherein the one or more sides of the panel are coupled to the first section via a perforated edge.

12. The label of claim 1, wherein the label is configured for attachment to a letter, package, or other parcel.

13. The label of claim 1, comprising a third section attached to the second section.

14. The label of claim 13, wherein one or more of the second section and the third section comprise one or more of a promotional message, a commercial message, an advertizing message, a personal message, and a return mailing label.

15. The label of claim 13, wherein the third section is detachable from the second section on a side that is opposite the side at which the second section is attached to the first section.

16. The label of claim 15, wherein the second section is attached to the first section via a score line.

17. The label of claim 16, wherein the third section is attached to the second section via a fold line.

18. The label of claim 17, wherein the second section and the third section are configured such that upon pivoting the third section about the fold line, and upon pivoting the second section about the score line, the second section and the third section are positioned adjacent to the underside of the first section, and the sides of the panel are configured such that a removal of the panel from the first section exposes the second section and the third section, and wherein the first section comprises a perimeter around the panel such that when the second section and third section are positioned adjacent to the underside of the first section, the perimeter outlines the second section and the third section.

19. The label of claim 18, wherein upon positioning the second section and the third section adjacent to the underside of the first section, a subsection adjacent to the score line is exposed, the subsection comprising an adhesive on an underside of the subsection.

20. The label of claim 19, comprising a perimeter around the first section, the perimeter comprising an adhesive on an underside of the perimeter.

21. The label of claim 1, wherein the first section comprises one or more of addressor information, addressee information, shipper information, and a computer readable code.

22. A label comprising:
a first section; and
a second section detachably coupled to the first section;
wherein the first section comprises a panel, the panel comprising one or more sides that are detachable from the first section;
wherein the panel is substantially centered within an area of the first section;
wherein the first section comprises a subsection at a point of attachment between the first section and the second section such that upon pivoting the second section about the point of attachment, the second section separates from the first section and exposes an underside of the subsection, wherein the underside of the subsection comprises an adhesive; and
wherein the first section and second section are configured such that upon pivoting the second section, the second section is positioned adjacent to the underside of the first section, and the sides of the panel are configured such that a removal of the panel from the first section exposes the second section.

23. The label of claim 22, comprising an adhesive on an underside of the first section and an adhesive on an underside of the second section.

24. The label of claim 22, comprising a third section attached to the second section.

25. The label of claim 24, wherein the third section is detachable from the second section on a side that is opposite the side at which the second section is attached to the first section.

26. The label of claim 25, wherein the second section is attached to the first section via a score line.

27. The label of claim 26, wherein the third section is attached to the second section via a fold line.

28. The label of claim 27, wherein the second section and the third section are configured such that upon pivoting the third section about the fold line, and upon pivoting the second section about the score line, the second section and the third section are positioned adjacent to an underside of the first section; and the sides of the panel are configured such that a removal of the panel from the first section exposes the second section and the third section, and wherein the first section comprises a perimeter around the panel such that when the second section and third section are positioned adjacent to the underside of the first section, the perimeter outlines the second section and the third section.
